(19) United States
(12) Patent Application Publication
(10) Pub. No.: US 2007/0067402 A1
(43) Pub. Date: Mar. 22, 2007

(54) Apparatus, program and method for sending and receiving electronic mail

(76) Inventors: Masato Sugii, Kawasaki-shi (JP); Nobumi Kusano, Ebina-shi (JP); Takanori Masui, Ebina-shi (JP); Makoto Takada, Ebina-shi (JP)

Correspondence Address: GAUTHIER & CONNORS, LLP, 225 FRANKLIN STREET, SUITE 2300, BOSTON, MA, 02110, US

(21) Appl. No.: 11/403,085

(22) Filed: Apr. 12, 2006

(30) Foreign Application Priority Data
Sep. 22, 2005 (JP) 2005-276103

(51) Int. Cl. G06F 15/16

(52) U.S. Cl. 709/206

(57) ABSTRACT

An electronic mail sending and receiving apparatus includes a receiver which receives an electronic mail message, an inbound security processing unit which performs an inbound security processing on the received electronic mail message in accordance with a security requirement that the received electronic mail message satisfies, a transmitter which sends an electronic mail message, an outbound security processing unit which performs an outbound security processing on the electronic mail message to be sent, and a requesting unit. The requesting unit issues a message disposition notification requests the recipient of the electronic mail message sent from the transmitter to transmit, upon opening of the electronic mail message, a return electronic mail message notifying that the electronic mail message has been opened.

### PRIORITY INFORMATION

This application claims priority to Japanese Patent Application No. 2005-276103 filed on Sep. 22, 2005, which is incorporated herein by reference in its entirety.

### BACKGROUND

1. Technical Field

The present invention relates to a technology enabling a sender of an electronic mail message to verify that the electronic mail message was opened at the intended recipient, and more particularly to a security technology in a verification process.

2. Related Art

There has been known a technology for requesting a recipient of an electronic mail (email) message to send, upon opening of the email message, a return to the sender an email message acknowledging opening of the email message. However, the mere receipt of an acknowledgement message does not ensure that the original email message was received by the intended recipient, or verification that the original email message was not tampered.

To provide such assurance, the adoption of public key cryptography can be considered as a means to enhance security for email. However, public key cryptography creates an inconvenient burden when apparatuses which do not support the addition of digital signatures to email messages are present in the communication loop. As a still further problem specific to return receipt functions, when the sender of an original email message has set their email hardware or software to reject receipt of email messages without digital signatures, the recipient of the original email message confirming receipt requires that the recipient be forced to attach a digital signature to a return email message, which may be neither welcome nor possible.

### SUMMARY

An aspect of the present invention provides an electronic mail sending and receiving apparatus including a receiver which receives an electronic mail message; an inbound security processing unit which performs, on the received electronic mail message, an inbound security processing in accordance with a security requirement that the received electronic mail message satisfies; a transmitter which sends an electronic mail message; an outbound security processing unit which performs, on the electronic mail message to be sent, an outbound security processing in accordance with the security requirement; and a requesting unit which initiates a message disposition notification request requesting a destination recipient of the electronic mail message sent from the transmitter to transmit, upon opening of the electronic mail message, a return electronic mail message acknowledging that the electronic mail message has been opened.

According to one aspect of the present invention, there is provided a storage medium readable by a computer storing a program of instructions executable by the computer to perform a function including receiving an electronic mail message; performing an inbound security processing on the received electronic mail message in accordance with a security requirement that the received electronic mail message satisfies; sending an electronic mail message; performing an outbound security processing on the electronic mail message to be sent in accordance with the security requirement; and communicating a message disposition notification request that requests a recipient of the electronic mail message sent by the sending function to transmit, upon opening of the electronic mail message, a return electronic mail message notifying that the electronic mail message has been opened.

According to another aspect of the present invention, there is provided a method for handling an electronic mail, including performing an inbound security processing to a received electronic mail message in accordance with a security requirement that the received electronic mail message satisfies; performing an outbound security processing on an outgoing electronic mail message in accordance with the security requirement, and subsequently sending the electronic mail message; and communicating a message disposition notification request that requests the recipient of the outgoing electronic mail message, upon opening of the outgoing electronic mail message, to transmit a return electronic mail message notifying that the outgoing electronic mail message has been opened.

According to still another aspect of the present invention, there is provided an electronic mail sending and receiving apparatus including a unit which receives an electronic mail message; an accepting unit which accepts, from a sender of the received electronic mail message, a message disposition notification request that requests, upon opening of the electronic mail message, transmission of a return electronic mail message notifying that the electronic mail message has been opened; and a sending unit which, when the message disposition notification request has been accepted, performs an outbound security processing in accordance with a security requirement that the received electronic mail message satisfies on the return electronic mail message, and subsequently sends the return electronic mail message.

According to a further aspect of the present invention, there is provided a storage medium readable by a computer storing a program of instructions executable by the computer to perform a function including receiving an electronic mail message; accepting a message disposition notification request issued from a sender of the received electronic mail message for requesting upon opening of the electronic mail message to transmit a return electronic mail message notifying that the electronic mail message has been opened; and, when the message disposition notification request is accepted, performing on the return electronic mail message, upon opening, an outbound security processing in accordance with a security requirement that the received electronic mail message satisfies, and subsequently sending the return electronic mail message. According to a still further aspect of the present invention, there is provided a method for handling an electronic mail including receiving an electronic mail message; accepting, from a sender of the received electronic mail message, a message disposition notification request associated with the electronic mail message which requests, upon opening of the electronic mail message, transmission of a return electronic mail message notifying that the electronic mail message has been opened; and,

when the message disposition notification request has been accepted, performing on the return electronic mail message an outbound security processing, upon opening of the received electronic mail message having the message disposition notification request, in accordance with a security requirement that the received electronic mail message satisfies, and subsequently sending the return electronic mail message.

### BRIEF DESCRIPTION OF THE DRAWINGS

Embodiments of the present invention will be described in detail based on the following figures, wherein:

FIG. 1 is a block diagram showing an example configuration of an email sending and receiving apparatus;

FIG. 2 is a flowchart explaining an example of process steps in transmission;

FIG. 3 is a flowchart explaining an example of process steps in response, and

FIG. 4 is a flowchart explaining an example of process steps in receipt of a response result.

### DETAILED DESCRIPTION

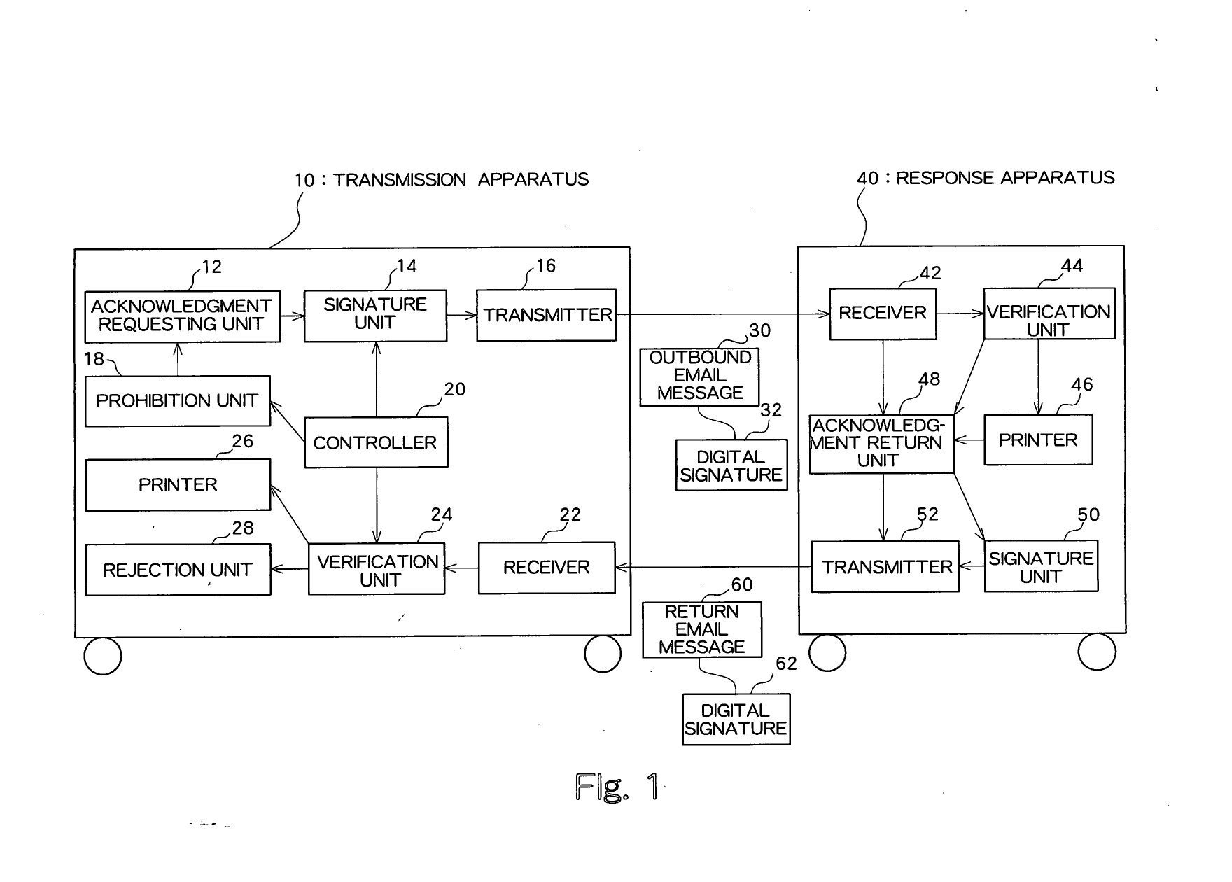

FIG. 1 is a schematic block diagram showing an example configuration of an email sending and receiving apparatus. The email sending and receiving apparatus shown in FIG. 1 is configured with a transmission apparatus 10 and a response apparatus 40. Although both of the apparatuses are intended to be a multifunction machine having an email sending/receiving function and incorporating a scanner and a printer, configurations other than those directly associated with the email sending/receiving function are not illustrated in FIG. 1. Each function of the transmission apparatus 10 and the response apparatus 40 is implemented through software control of hardware having a computing capability.

The transmission apparatus 10 initially sends an email message to the response apparatus 40. It is also possible to cause the response apparatus 40 to initially send the email message to the transmission apparatus 10. The configuration shown in FIG. 1, however, in which it is assumed that the email message is first sent from the transmission apparatus 10. The transmission apparatus 10 has an acknowledgment requesting unit 12, a signature unit 14, a transmitter 16, a prohibition unit 18, a controller 20, a printer 26, a rejection unit 28, a verification unit 24, and a receiver 22.

The acknowledgment requesting unit 12 attaches a request for MDN (Message Disposition Notification) to an email message to be sent. When an email message with an MDN request attached is opened by a recipient, the recipient is requested to send a return email message acknowledging that the email message has been opened. The signature unit 14 works to affix a digital signature to email messages. More specifically, the digital signature is added using a private key which is specific to the transmission apparatus 10 or to each operating user. The transmitter 16 sends email messages. The prohibition unit 18 is a component with the ability to prohibit the acknowledgment request unit 12 from issuing the request for MDN. The controller 20 controls the signature unit 14 and the prohibition unit 18. More specifically, the controller 20 determine whether or not to cause the signature unit 14 to affix a digital signature and whether or not to cause the prohibition unit 18 to prohibit issuing of the request for MDN.

The receiver 22 receives email messages. When a received email message includes a digital signature, the verification unit 24 authenticates the digital signature using an appropriate public key. Usually, a public key can be obtained from a Certification Authority over a network.

The printer 26 prints a hardcopy of a received email message. Specifically, the printer 26 prints the received email message and an image attached to the received email message using a printing function. The rejection unit 28 rejects receipt of incoming email messages. In other words, upon receipt of an email message, the rejection unit 28 sends the email message back to the sender of the email message before printing or distributing the email message to users. Operations of the printer 26 and the rejection unit 28 may depend on the result of verification in the verification unit 24. More specifically, there may be cases wherein the results obtained in the verification unit 24 reveal that a received email message has no digital signature or has an illegal digital signature. The printer 26 may be configured to disable printing operation in that case, or the rejection unit 28 may be configured to reject receipt of the email message in that case. In other words, the printer 26 and the rejection unit 28 maintain security at a level determined adequate in consideration of the security requirement (a security level) met by the received email message.

The controller 20 can change control modes of the signature unit 14 and the prohibition unit 18 according to verification operation settings in the verification unit 24. For example, when it is specified that only receipt of email messages including reliable digital signatures is allowed, the signature unit 14 may be forced to affix the digital signature to the email message to be sent, or the prohibition unit 18 may be forced to prohibit the request for MDN from being issued. In other words, the controller 20 is capable of selectively enabling or disabling processes of affixing the digital signature to the email message to be sent and making the request for MDN in accordance with the security requirement that the received email message satisfies.

An outgoing email message 30 is sent via a network from the transmitter 16. Typically, the request for MDN and a digital signature 32 are attached to the outgoing email message 30.

The response apparatus 40 has a receiver 42, a verification unit 44, a printer 46, an acknowledgment returning unit 48, a signature unit 50, and a transmitter 52. The receiver 42 receives email messages, and the verification unit 44 confirms whether or not a digital signature is attached to a received email message. When it is confirmed that the received email message has a digital signature, the verification unit 44 then authenticates the digital signature using an appropriate public key or a public key certificate. The printer 46 creates a printout from the email message using a printing function. As in the case of the transmission apparatus, operation of the printer 46 may depend on the results of verification in the verification unit 44.

The acknowledgment returning unit 48 performs processing when an email message is received with an attached request for MDN. More specifically, the request for MDN is obtained from the email message received in the receiver 42 to generate an email message for response (a return email message) 60. The signature unit 50 affixes a digital signature to the return email message 60 using a private key specific to the response apparatus 40 or a private key for a registered user. Then, the transmitter 52 sends the return email message 60 to the transmission apparatus 10.

The acknowledgment returning unit 48 may determine whether or not a digital signature should be affixed to the return email message according to the verification results obtained in the verification unit 44. More specifically, the signature unit 50 may be controlled to add a digital signature only when it is determined that the received email message is accompanied with a reliable digital signature. Further, the acknowledgment returning unit 48 may include in the return email message 60 the verification results obtained in the verification unit 44. In this manner, the verification results can themselves be confirmed in the transmission unit 10.

Thus, the response apparatus 40 sends the return email message 60 via a network to the transmission apparatus 10. Typically, the digital signature 62 is affixed to the return email message 60.

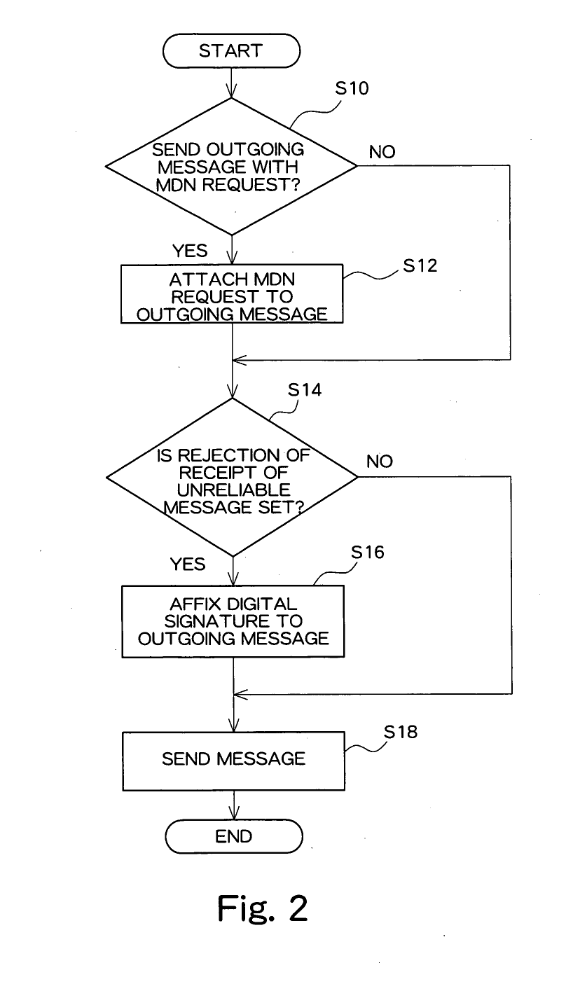

Next, operation of the transmission apparatus 10 and the response apparatus 40 will be described with reference to the flowcharts shown in FIGS. 2, 3, and 4.

FIG. 2 is a flowchart explaining process steps for sending an email message in the transmission apparatus 10. When an an email message is sent, whether or not to make a request for MDN is normally determined according to an input from a user (S10). The request for MDN is accomplished by the acknowledgment requesting unit 12 attaching to the email message to be sent (S12) a request for MDN.

A decision as to whether or not to affix a digital signature to an outgoing email message is made based on whether or not receipt of the email message depends on the result of verification in the verification unit 24 (S14). In other words, when acceptable email messages are limited to those having a digital signature successfully authenticated in the verification unit 24, the digital signature of the transmission apparatus 10 is affixed to the outgoing email messages (S16). Finally, the transmitter 16 sends the email message.

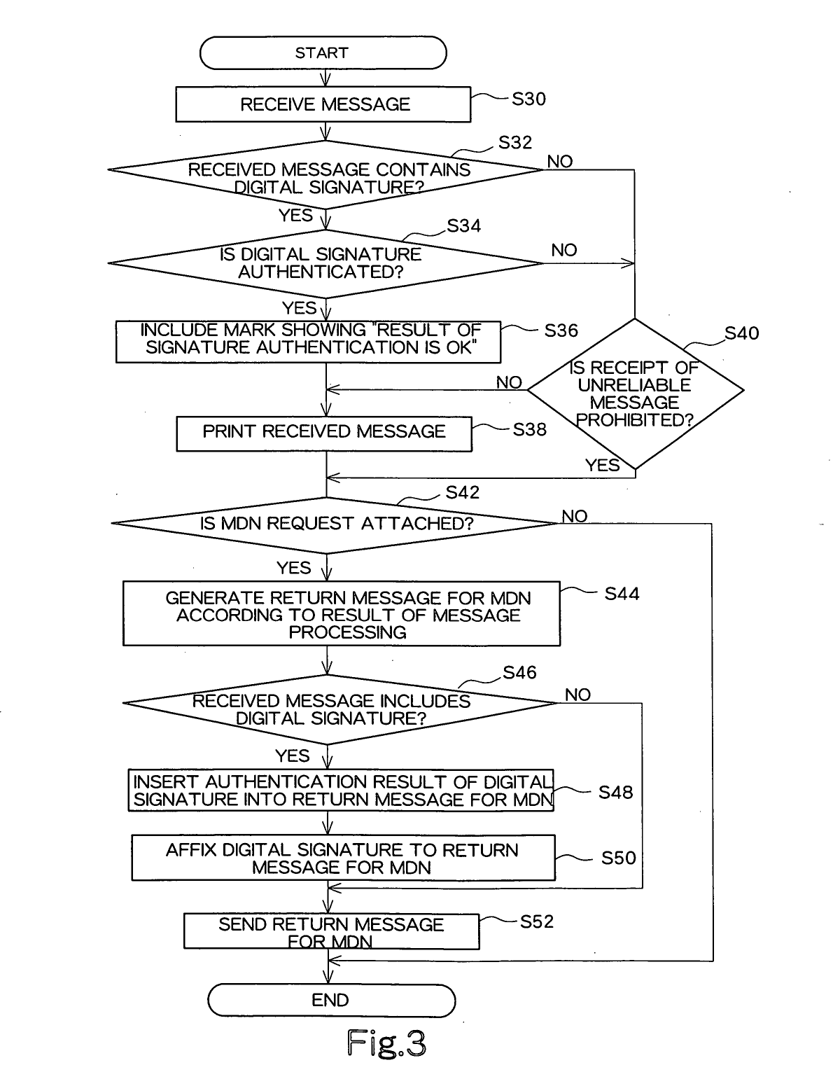

FIG. 3 is a flowchart explaining a flow of process steps in the response apparatus 40. The receiver 42 initially receives an email message in the response apparatus 40 (S30). Then, the verification unit 44 detects the presence or absence of a digital signature (S32). If the presence of a digital signature is detected, the verification unit 44 authenticates the digital signature based on a corresponding public key certificate (S34). If the digital signature is determined to be reliable, a setting for attaching the result of authentication of the digital signature to a return email message is activated in the acknowledgment returning unit 48 (S36). Further, the printer 46 creates a printout from the received email message (S38).

On the other hand, if no digital signature is detected, or authentication of the digital signature has failed, it is confirmed whether or not receipt of unreliable email messages is prohibited (S40). When the receipt of unreliable email messages is not prohibited, the printer 46 creates a printout from the email message. On the other hand, when the receipt of unreliable email messages is prohibited, operation proceeds to the next step without creating a printout.

The acknowledgment returning unit 48 verifies whether or not a request for MDN is attached to a received email message (S42). When it is determined that a request for MDN is attached, the acknowledgment returning unit 48 creates a return email message for sending to the sender of the received email message (S44). Further, whether or not the received email message has a digital signature is determined (S46). When no digital signature is found, the return email message is sent without being further processed (S52). When, on the other hand, a digital signature is found, the digital signature verification results are included into the return email message created in step S44 (S48), and the digital signature of the response apparatus 40 is affixed to the return email message (S50), which is then transmitted (S52).

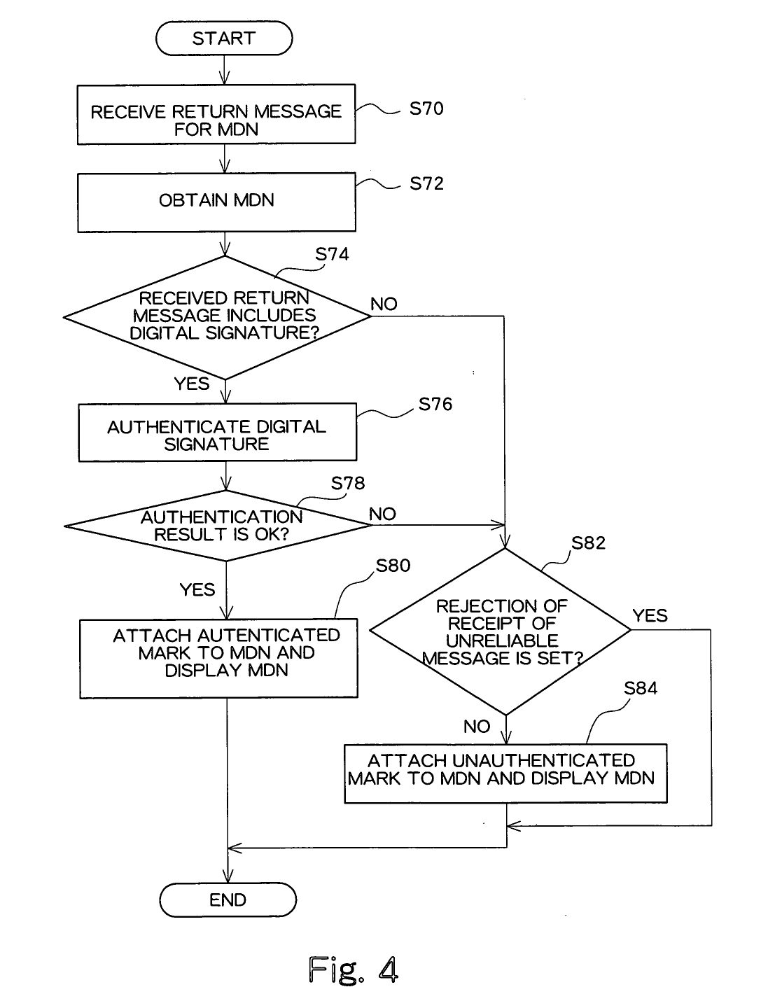

Next, referring to the flowchart shown in FIG. 4, a flow of process steps for receiving a return email message in the transmission apparatus 10 will be described. In the transmission apparatus 10, the receiver 22 receives a return email message (S70). Upon receipt of the return email message, an MDN can be obtained (S72). The verification unit 24 confirms whether or not the received return email message has a digital signature (S74). When the digital signature is found, verification is performed using the public key certificate (S76, S78). When reliability of the digital signature is ensured as a result of authentication, the MDN is provided with a mark representing verified status, and is printed by the printer 26 or displayed on a display screen.

On the other hand, when at step S74 no digital signature is found in the received return email message or the result of verification in step S78 shows that the digital signature is illegal, it is confirmed whether or not a rejection setting for blocking receipt of such an unreliable email message is specified (S82). When the rejection setting is specified, the rejection unit 28 performs processing for either returning or abandoning the received return email message. When, on the other hand, the rejection setting is not specified, the MDN is provided with a mark indicating its invalid status, and is printed by the printer 26 or displayed on the display screen.

Next, modifications and applications of the above-described embodiment of the present invention will be described.

In one application of the present invention, an email sending and receiving apparatus may be implemented with hardware connected to a network and capable of sending and receiving email messages, and software which controls processing operation of the hardware. The hardware may be a computer in a broad sense including, for example, a personal computer (PC), a facsimile, a multifunction machine (in which a scanner, a printer, or the like are integrated). The email sending and receiving apparatus may include a receiving unit, an inbound security processing unit, a sending unit, an outbound security processing unit, and a requesting unit.

In such an application, the receiving unit is a component for receiving email messages. An inbound security processing unit is a component in which an inbound security processing is performed on received email messages. Here, the inbound security processing refers to a processing for improving security, such as, for example, a processing of abandoning email messages, a processing of warning a user, or the like. The inbound security processing unit performs the inbound security processing in accordance with a security requirement that a received email message satisfies. Here, the security requirement refers to conditions for a security level to be satisfied, and may include a condition as to whether or not at least one of encryption and affixation of digital signature using public key cryptography is implemented, a condition as to whether or not an email address of a sender is appropriate, and a condition as to whether or not a file containing a virus or the like is attached.

The sending unit is a component for sending email messages. An outbound security processing unit is a component in which an outbound security processing is performed on email messages to be sent. The outbound security processing refers to processing associated with an operation of changing outbound security levels, such as, for example, a process of performing at least one of encryption and affixation of a digital signature using public key cryptography, a process of entering a desired security level in a return email message, and the like. The outbound security processing unit performs one or more of the outbound security processes specified in accordance with one or more security requirements. The security level to be attained through the outbound security processing is typically set to a level demanded by security requirements, but may be set to different level as desired or considered preferable.

The requesting unit issues a request for MDN to a destination of an email message. The request for MDN is a request for transmission of a return email message acknowledging that the email message having been sent was opened. Here, opening of the email message refers to a state in which the body of the email message is provided to a user in readable form. Although the request for MDN is typically embedded in the email message, the MDN may be requested in a manner separated from the email message.

In the above-described configuration, the outbound security processing corresponding to the security requirement associated with the inbound security processing is performed on the email message to be sent. The return email message is generally expected to retain a security level equivalent to that of the original email message. For this reason, when a received email message satisfies a high level security requirement, the security level of the email message to be sent in acknowledgement is set at a comparably high level. In this manner, it becomes possible to affix the digital signature while addressing a problem that receipt of the return email message is rejected.

In one modified example of the email sending and receiving apparatus according to the present invention, the security requirement is a condition that a digital signature is affixed. The use of the digital signature can facilitate prevention of tampering with the received email message. Verification is generally performed using a public key certificate. Alternatively, the security requirement may be a condition that a reliable digital signature is affixed. A reliable digital signature is a successfully authenticated digital signature.

In another embodiment of the email sending and receiving apparatus according to the present invention, the outbound security processing is a processing for affixing a digital signature to an email message to be sent. The digital signature may be a digital signature of the email sending and receiving apparatus, or may be one owned by a user of the email sending and receiving apparatus. As another example of the outbound security processing, there may be considered a processing of providing an email message with an instruction for affixing a digital signature to a return email message.

In still another modification of the email sending and receiving apparatus according to the present invention, the inbound security processing unit may perform, as the inbound security processing applied to an email message which does not satisfy the security requirements, at least one of a discard processing, a processing of warning a user, and a processing for notifying a sender of rejected receipt (also referred to as receipt blocking). When the email sending and receiving apparatus of the present invention includes a printer for printing images of or from the received email message, the inbound security processing unit may perform, as the inbound security processing applied to the email message which does not satisfy the security requirement, a processing of prohibiting mandatory image formation from the email message. In this example in which the printer is provided, information showing the verification results may be printed when verification has succeeded, when it has failed, or regardless of the results of verification.

In a still further example of the present invention, the email sending and receiving apparatus may additionally include a prohibition unit which prohibits the requesting unit from issuing the request for MDN according to an established security requirement. For example, when the inbound security processing unit is configured to refuse receipt of an email message having no digital signature, attachment of the request for MDN is prohibited. In this manner, when a return email message has no digital signature, a situation in which receipt of the return email message is refused can be prevented. It should be noted that provision of the prohibition unit can eliminate the need to provide an outbound security processing unit. As such, an email sending and receiving apparatus configured by the receiving unit, the requiring unit, and the prohibition unit may be realized.

In yet another example of the present invention, the email sending and receiving apparatus may further include a verification unit which authenticates a digital signature attached to the received email message and a notification unit which includes the results of the verification of the digital signature in the return email message. Determination as to whether to communicate the results of verification, and the form and content of communication, may be made in consideration of whether or not the received email message satisfies a particular security requirement.

Although a preferred embodiment of the present invention was described above with a certain degree of detail, it is to be understood that the invention is not limited to the above-described examples, and that various modifications and changes may be made without departing from the spirit or scope of the following claims. For example, the present invention may be understood as a method in which a computer performs the process steps corresponding to each unit. In this case, it is not necessary that an execution sequence of the process steps is identical with the order in which the process steps are described with respect to each unit in the above.

What is claimed is:

1. An electronic mail sending and receiving apparatus comprising:
a receiver which receives an electronic mail message;
an inbound security processing unit which performs, on the received electronic mail message, an inbound security processing in accordance with a security requirement that the received electronic mail message satisfies;
a transmitter which sends an electronic mail message;
an outbound security processing unit which performs, on the electronic mail message to be sent, an outbound security processing in accordance with the security requirement; and
a requesting unit which communicates a message disposition notification request which requests a recipient of the electronic mail message sent from the transmitter to transmit, upon opening the electronic mail message sent from the transmitter, a return electronic mail message notifying that the electronic mail message has been opened.

2. The electronic mail sending and receiving apparatus according to claim 1, wherein
the security requirement is a condition that a digital signature is affixed.

3. The electronic mail sending and receiving apparatus according to claim 2, wherein
the outbound security processing is a processing of affixing a digital signature to the electronic mail message to be sent.

4. The electronic mail sending and receiving apparatus according to claim 1, wherein
the outbound security processing is a processing of affixing a digital signature to the electronic mail message to be sent.

5. The electronic mail sending and receiving apparatus according to claim 1, wherein
the outbound security processing is a processing of issuing an instruction for affixing a digital signature to the return electronic mail message.

6. The electronic mail sending and receiving apparatus according to claim 1, wherein
the inbound security processing unit performs, as the inbound security processing applied to an electronic mail message which does not satisfy the security requirement, at least one of a discard processing, a processing of warning a user, and a processing of providing a sender with notification that receipt of an electronic mail message sent from the sender has been rejected.

7. The electronic mail sending and receiving apparatus according to claim 1, further comprising:
a printer which generates a paper printout from the received electronic mail on paper, wherein
the inbound security processing unit performs, as the inbound security processing applied to an electronic mail message which does not satisfy the security requirement, a processing of prohibiting the printer from printing an image from the electronic mail message.

8. The electronic mail sending and receiving apparatus according to claim 1, further comprising:
a prohibition unit which prohibits the requesting unit from issuing the message disposition notification request in accordance with the security requirement.

9. The electronic mail sending and receiving apparatus according to claim 1, wherein
the message disposition notification request issued from the requesting unit is attached to the electronic mail message to be sent from the transmitter.

10. A storage medium readable by a computer storing a program of instructions executable by the computer to perform a function comprising:
receiving an electronic mail message;
performing an inbound security processing on the received electronic mail message in accordance with a security requirement that the received electronic mail message satisfies;
sending an electronic mail message;
performing an outbound security processing on the electronic mail message to be sent in accordance with the security requirement; and
communicating a message disposition notification request which requests a recipient of the electronic mail message sent by the sending function to transmit, upon opening the electronic mail message, a return electronic mail message notifying that the electronic mail message has been opened.

11. A method for handling an electronic mail, comprising:
performing an inbound security processing on a received electronic mail message in accordance with a security requirement that the received electronic mail message satisfies;
performing an outbound security processing on an outgoing electronic mail message in accordance with the security requirement, and subsequently sending the electronic mail message; and
communicating a message disposition notification request which requests a recipient of the electronic mail message sent by the sending function to transmit, upon opening the electronic mail message, a return electronic mail message notifying that the outgoing electronic mail message has been opened.

12. An electronic mail sending and receiving apparatus comprising:
a unit which receives an electronic mail message;
an accepting unit which accepts, from a sender of the received electronic mail message, a message disposition notification request that requests, upon opening of the electronic mail message, transmission of a return electronic mail message notifying that the electronic mail message has been opened; and
a sending unit which, when the message disposition notification request has been accepted, performs on the return electronic mail message, upon opening the received electronic mail message, an outbound security processing in accordance with a security requirement satisfied by the received electronic mail message, and subsequently sends the return electronic mail message.

13. The electronic mail sending and receiving apparatus according to claim 12, wherein
when the received electronic mail message satisfies a condition that a digital signature is attached as the security requirement, the sending unit affixes a digital signature to the return electronic mail message as the outbound security processing and sends the return electronic mail message including the digital signature.

14. The electronic mail sending and receiving apparatus according to claim 12, further comprising:
a verification unit which authenticates a digital signature affixed to the received electronic mail message, and
a notification unit which includes a result of authentication of the digital signature in the return electronic mail message.

15. A storage medium readable by a computer storing a program of instructions executable by the computer to perform a function comprising:
receiving an electronic mail message;
accepting a message disposition notification request issued from a sender of the received electronic mail message for requesting, upon opening of the electronic mail message, transmission of a return electronic mail message notifying that the electronic mail message has been opened; and
when the message disposition notification request is accepted, performing on the return electronic mail message, upon opening of the received electronic mail message, an outbound security processing in accordance with a security requirement that the received electronic mail message satisfies, and subsequently sending the return electronic mail message.

16. A method for handling an electronic mail comprising:
receiving an electronic mail message;
accepting, from a sender of the received electronic mail message, a message disposition notification request associated with the electronic mail message which requests, upon opening of the electronic mail message, transmission of a return electronic mail message notifying that the electronic mail message has been opened; and
when the message disposition notification request has been accepted, performing, upon opening of the received electronic mail message containing the message disposition notification request, an outbound security processing on the return electronic mail message in accordance with a security requirement that the received electronic mail message satisfies, and subsequently sending the return electronic mail message.
